(19) United States
(12) Patent Application Publication
(10) Pub. No.: US 2010/0322513 A1
(43) Pub. Date: Dec. 23, 2010

(54) Skin and sky color detection and enhancement system

(75) Inventors: Xinyu Xu, Vancouver, WA (US); Hao Pan, Camas, WA (US)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 12/456,604

(22) Filed: Jun. 19, 2009

(51) Int. Cl. G06K 9/00

(52) U.S. Cl. 382/167

(57) ABSTRACT

An image enhancement technique that includes a filter that receives an image and generates a filtered image primarily including lower frequency content and sharp edges of the image. A skin color processing is based upon the filtered image to enhance skin tone regions of the image. A sky color processing is based upon the filtered image to enhance sky color regions of the image. A combiner calculates an output image based upon the skin color processing, the sky color processing, and higher frequency content of the image.

### CROSS-REFERENCE TO RELATED APPLICATIONS

Not applicable.

### BACKGROUND OF THE INVENTION

The present invention relates generally to a display system for improved sky and skin colors.

Sky is a subject matter seen in images. The identification of sky in images facilitates its enhancement. The most prominent characteristic of sky tends to be its color, which is usually light blue when the sky is clear. Such a characteristic has been used to detect sky in images.

There exists conventional techniques for enhancing the color of a color image. One enhancement technique involves image-dependent color saturation correction in a natural scene pictorial image disclosed in U.S. Pat. No. 5,450,217. In this method, color saturation is enhanced in an HSV color space, which is considered as being capable of representing an image to have almost the same saturation as a recognized saturation of the image. However, this method can enhance the color saturation of certain images only, which have an average saturation of no higher than a certain threshold value.

Skin tones are a subject matter seen in images. The identification of a persons' skin tones in images facilitates its enhancement and image manipulation. One of the most prominent characteristic of skin tones is the face of users, and viewers prefer the skin tones they observe to have the anticipated visual characteristics.

What is desired is a display with an image enhancement technique that improves the presentation of sky and skin colors.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates displays and color gamuts.

FIGS. 2A and 2B illustrate different image enhancement techniques.

FIGS. 3A and 3B illustrate skin and sky distributions.

FIGS. 4A and 4B illustrate skin and sky look up tables.

FIG. 5 illustrates a skin enhancement technique.

FIG. 6 illustrates a sky enhancement technique.

### DETAILED DESCRIPTION OF PREFERRED EMBODIMENT

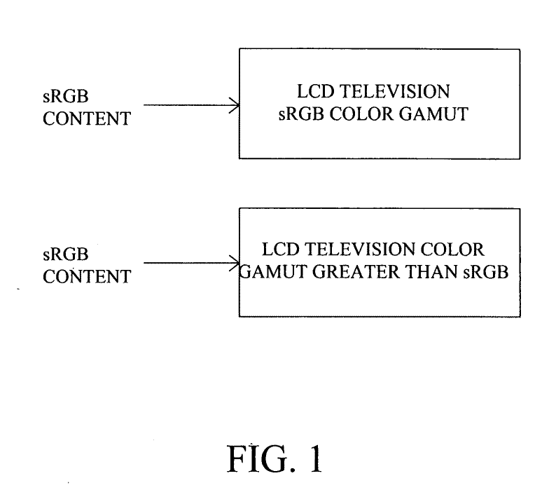

Referring to FIG. 1, the color space of standard high definition television source material frequently has the sRGB color gamut. The video having the sRGB color gamut is provided to a display to be displayed. For a liquid crystal display having a sRGB color gamut, then the rendered image on the display generally matches the color gamut of the input video content in a one-to-one relationship. In this manner, the displayed image is properly displayed, with different image content being displayed as the viewer generally anticipates.

In many cases, the color gamut of liquid crystal displays have a color gamut that is significantly larger, at least in some respects, than the sRGB color gamut of the source content. Accordingly, a mapping technique is used to expand the sRGB color gamut of the source content to the color gamut of the display. With a larger color gamut for displaying the image, the mapping technique may provide more pleasing colors for natural objects. Among the natural objects of particular interest to viewers of the source content are sky portions of the image and skin portions of the image.

The preference of many viewers is that the sky is modified to have saturated colors. With the larger color gamut of the display, in relation to the smaller color gamut of the source content, it is more feasible than otherwise to increase the saturation of the sky. In contrast, the preference of many viewers is that the skin is not similarly modified to have saturated colors. With the larger color gamut of the display, in relation to the smaller color gamut of the source content, it is preferable to generally maintain the same saturation of the skin because of viewer preferences.

A framework is desirable in order to provide the capability of providing both skin detection and sky detection, together with rendering a smaller color gamut input on a larger color gamut display, while enhancing the sky colors and not similarly enhancing the skin tone colors. The detection and rendering framework should likewise facilitate the detection and rendering in a manner that reduces the enhancement of noise. The framework may be extended to other features in an image, such as green grass.

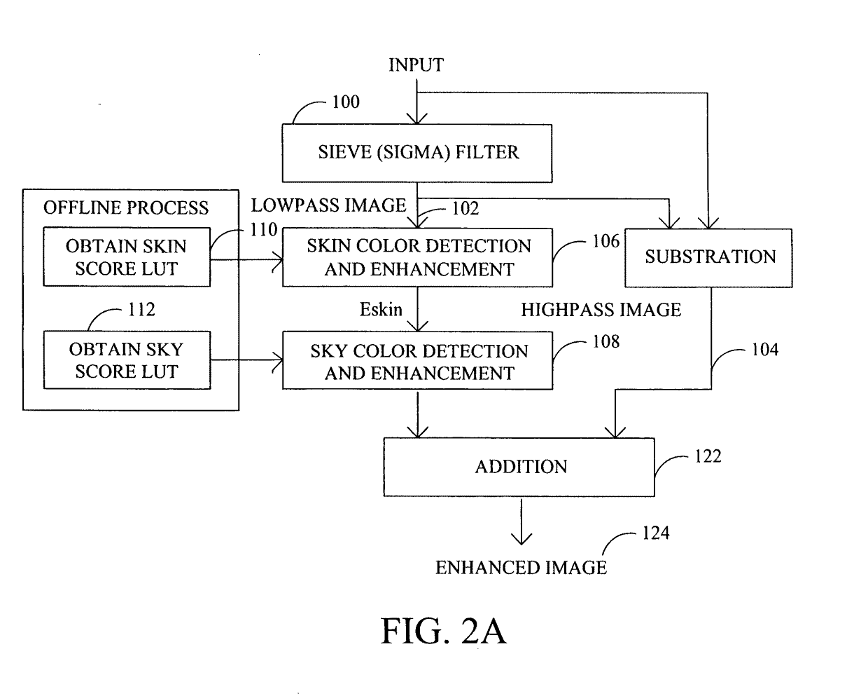

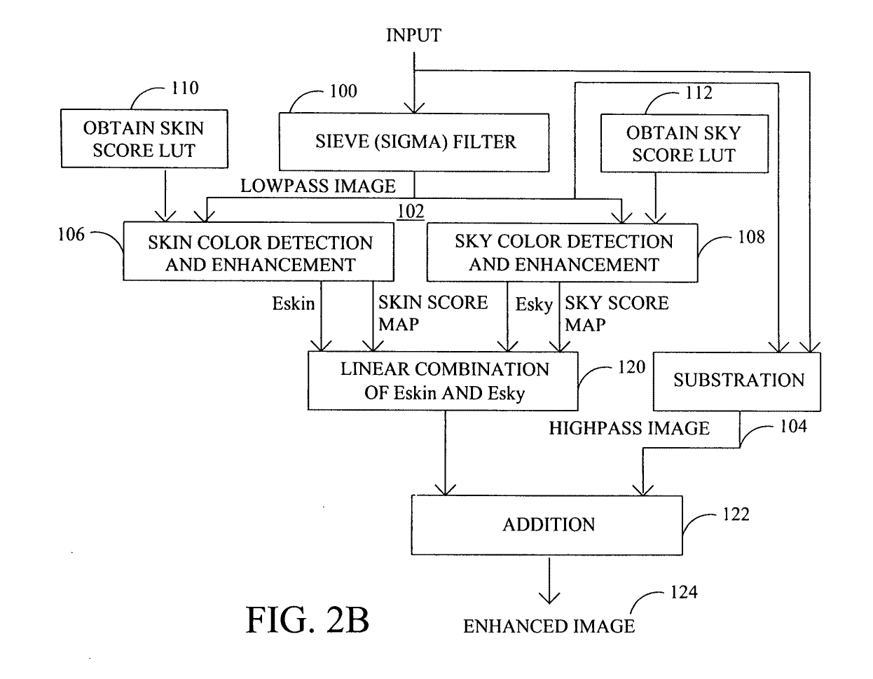

Referring to FIG. 2A a sequential mode framework is illustrated, while referring to FIG. 2B a parallel mode framework is illustrated. In either the sequential mode or the parallel mode, a sigma filter 100 decomposes the input image into low pass 102 and high pass 104 images. The sigma filter utilizes a 1-D or 2-D rectangular window, where the current pixel I(x,y) is at the center of the window. The sigma filter compares the pixels I(i,j) in the window with the central pixel I(x,y), and averages those pixels whose value differences with the central pixel I(x,y) is within a threshold T. Because the sigma filter drops pixels that are not within the threshold, one may generally refer to this filter as a sigma filter. The sigma filter is a nonlinear filter. Mathematically, the output of the sigma filter, I_{LP}(x,y), may be calculated by

$${I}_{LP} ( x , y ) = \frac{{\sum }_{( i , j ) ∈ E \& \vert I ( i , j ) - I ( x , y ) \vert < T} I ( i , j )}{N ( x , y )}$$

where E is the window; N(x,y) is the count of the pixels in E that satisfy the condition of |I(i,j)−I(x,y)|<T. The parameters of the sigma filter, the window E and the threshold T, may be selected empirically.

The sigma filter generates the low pass image 102, and the high pass image 104 may be readily obtained by subtraction. Because the sigma filter is a smoothing filter preserving sharp edges, the low pass image 102 generated by a sigma filter contains limited details but maintains sharp edges, and the high pass image 104 contains details/noises/artifacts but relatively few sharp edges. In general, the output of the sigma filter has the appearance of a cartoon. In general, by separating the image into a pair of channels, the lower frequency channel will contain relatively few artifacts and noise, and the higher frequency channel will contain relatively more artifacts and noise. By performing the enhancements primarily on the lower frequency channel, the artifacts and noise in the image will not tend to be enhanced in the final image.

It is to be understood that any suitable filter that decomposes an image into two or more channels where one channel generally contains the lower frequency characteristics of the image and another channel generally contains the higher frequency characteristics of the image. Preferably, the lower frequency channel also contains sharp edges of the image.

With respect to FIG. 2A, the technique performs skin color detection and enhancement 106, and sky color detection and enhancement 108, in a sequential manner. Because the human eye is more sensitive to variations in the skin tones, it is preferable to perform the skin color detection and enhancement 106, followed by the sky color detection and enhancement 108. In this manner, the skin tone enhancement will not be impacted by the results of the sky color enhancement 108. The skin color detection and sky color detection may be based upon a skin score look up table 110 and a sky score look up table 112, described below. The enhancement of the skin and sky may be mathematically expressed as:

y₁=ƒₛₖᵢₙ(c)=skinScore(c)×skinEnhance(c)+(1−skinScore(c))×c

yₒᵤₜ=skyScore(c)×skyEnhance(y₁)+(1−skyScore(c))×y₁

In the above equations, c represents the pixel color, skinScore(c) represents the skin color likelihood for color c, and skinEnhance(c) refers to enhanced skin color for color c, and ƒₛₖᵢₙ(c) represents the skin color enhancement function.

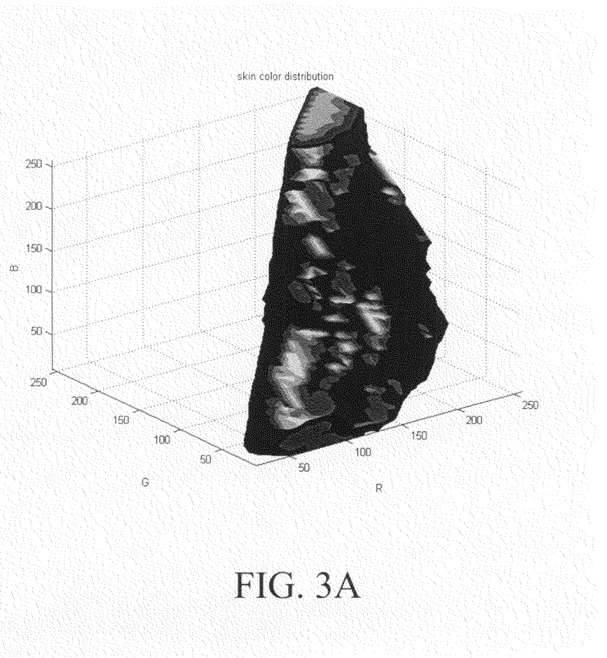

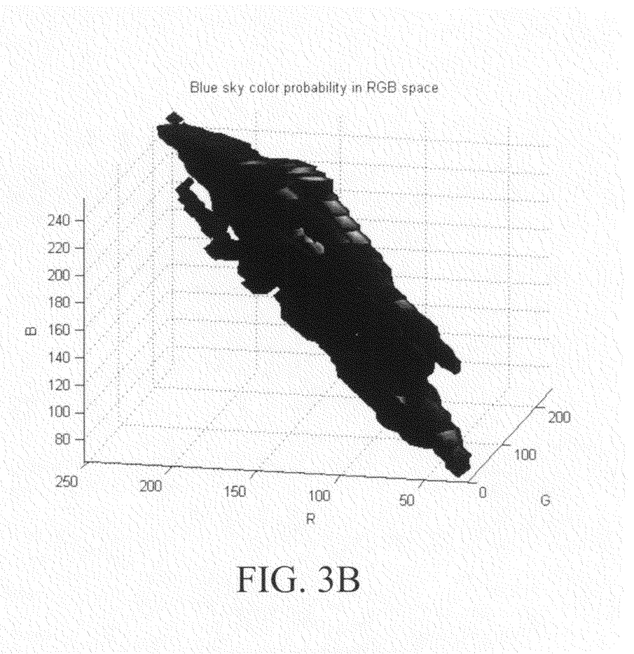

The skin and sky color probability may be computed from a color histogram of segmented training skin and sky regions. FIG. 3A shows one embodiment of the learned skin color probability, FIG. 3B shows one embodiment of the learned sky color probability. Skin and sky score, and skin and sky color probability may be scalars between 0 and 1, and skin and sky score may based on skin and sky color probability. Preferably the skin and sky color probability are not directly used as the skin and sky scores. The reasons is that, first, the three dimensional sky and skin color probability tends to contain abrupt changes in the color space, and it may also contain holes, both of which will tend to lead to a rough skin and sky likelihood map. Thus the sky and skin color probability distribution provides the baseline information for roughly deciding the location and size of the skin and sky color region in the color space. Secondly, due to the limited number of training skin and sky images, some skin and sky colors might not appear in the training set, therefore these colors will tend to have low probability in the learned probability region. This will lead to high false negative errors (skin and sky area is declared as non-skin and non-sky area) in the detection stage, and thus these areas will have loss of saturation boost in the rendering stage. Because of these reasons, it is preferred to build a skin 110 and sky score lookup table 112 based upon the initial skin and sky probability. The skin and sky probability is used to initialize the skin and sky score LUT, and then the LUT entries are fine tuned by testing on a large set of skin and sky, and non-skin and sky images. Another benefit of using skin and sky score lookup tables is that it allows different viewer groups to adjust its entry values, some viewer group prefers more saturated colors than the others and adjusting the sky score can fulfill this preference.

Skin and sky score is stored in look-tables (LUTs) in the skin and sky detection system. Skin and sky score LUTs are used to generate a skin and sky color likelihood map in the rendering technique. The values in the skin and sky score LUTs are first initialized from the skin/sky color probability, then the system fine-tunes the entries of LUTs by testing on a large set of skin and sky images.

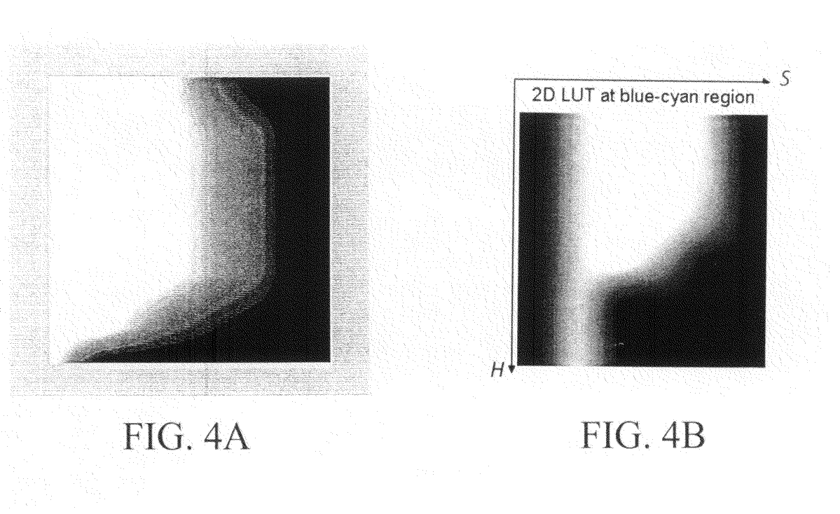

The system may define skin and sky score conceptually in a modified HSV color space. The RGB color space is divided into 6 areas, then define hue (H), saturation (S) and value (V) separately in the six areas, and finally define the sky score for each area. FIG. 4A shows the skin score LUT in the red-yellow area (red>green>blue), and FIG. 4B shows the sky score LUT in the blue-cyan area (blue>green>red).

Alternatively, any other sky and skin tone identification technique may be used. Moreover, any sky and skin tone enhancement technique may be used. Also, the identification of the sky and skin tones may be performed on-line, if desired. In addition, the skin and sky colors are preferably non-overlapping (or substantially non-overlapping).

Referring again to FIG. 2B, the skin 106 and sky detection 108, and skin 106 and sky 108 enhancement may be performed in a parallel manner. The enhanced result by the skin module and the sky module are combined using a weighted linear combination 120. The weights are the skin score and sky score respectively. In the case when both skin and sky score are 0, the output color is set to the input color c. This can be mathematically expressed as:

$${f}_{skin} ( c ) = skinScore ( c ) \times skinEnhance ( c ) + ( 1 - skinScore ( c ) ) \times c$$

$${h}_{sky} ( c ) = skyScore ( c ) \times skyEnhance ( c ) + ( 1 - skyScore ( c ) ) \times c$$

$$\{ \begin{matrix}{y}_{out} = c , & skinScore ( c ) = skyScore ( c ) = 0 \\ \begin{matrix}{y}_{out} = {skinScore ( c )}^{N} \times {f}_{skin} ( c ) + \\ {skyScore ( c )}^{N} \times {h}_{sky} ( c ) ,\end{matrix} & skinScore ( c ) \neq 0 \&\& skyScore ( c ) \neq 0\end{matrix}$$

In the above equations, ƒₛₖᵢₙ(c) and h_{sky}(c) corresponds to the skin and sky enhancement function respectively, and they work in parallel, skinScore(c)^{N} and skyScore(c)^{N} are normalized skin and sky score.

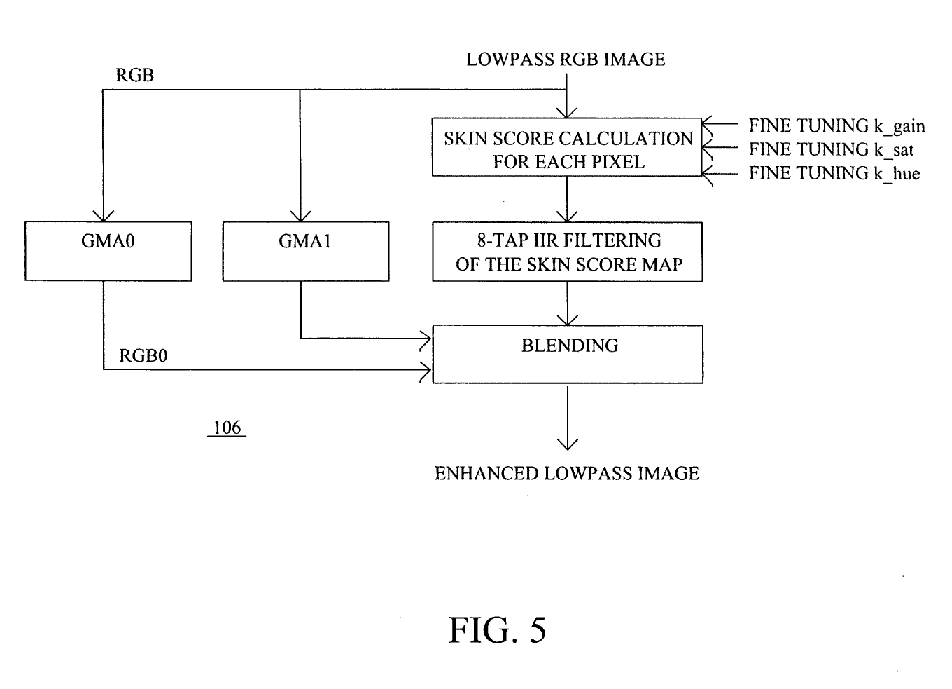

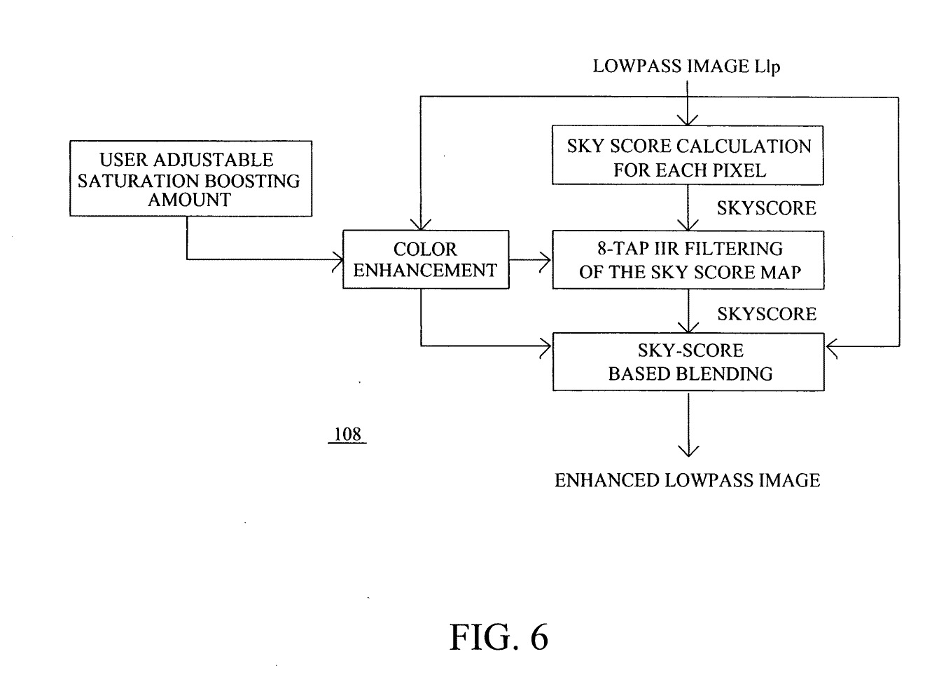

In both the sequential mode and the parallel mode, the input image is first decomposed into low pass and high pass images by a sigma filter. Only the low pass image, containing no details or artifacts, goes through the detection and enhancement path. The high pass image, containing details and noise and artifacts, does not go through the detection and enhancement path and will be added back 122 to the color enhanced low pass image to generate the enhanced image 124. Therefore, the noise in the high pass image is not enhanced. The skin color detection and enhancement and the skin color detection and enhancement are illustrated in more details in FIG. 5 and FIG. 6, respectively. Essentially, the skin-color enhanced image is weighted average of two gamut mappings (GMAs). One GMA preserves the sRGB colors in the new expanded color gamut, and the other GMA more fully utilizes the new expanded color gamut. The weights are determined by so-called skin score.

The block diagram of the skin color detection and enhancement algorithm is shown in FIG. 5. First, the algorithm calculates the skin score of the input color. Then, the skin score is spatially filtered by an 8-tap IIR spatial filter to further avoid contouring artifacts. At the same time, a conservative gamut map (GMA0) and an aggressive gamut map (GMA1) are computed. The two colors from two GMAs are blended.

Based on skin score, a mapped color is a blending of the colors mapped by two GMAs, GMA0 and GMA1. GMA0 is a conservative GMA that substantially (or exactly) reproduces sRGB colors in the wide color gamut and therefore protect skin colors. GMA1 is an aggressive GMA1 that stretches every sRGB colors to the wide color gamut. Mathematically, the blending may expressed as:

y=GMA(c)=skinScore(c)*GMA0(c)+(1−skinScore(c))*GMA1(c)

where skinScore (c) is the skin core of the input color c.

A standard linear mapping approach may be used in GMA0 to reproduce the sRGB color in the wide color gamut. Specifically, the input RGB first goes through sRGB gamma mapping, then is multiplied by the 3×3 conversion matrix, and finally goes back to the linear domain by inverse sRGB gamma mapping. Note that if sRGB is not 100% inside the new wide color gamut, then there are negative components in the 3×3 conversion matrix. GMA1 can be a gamut that uses up all the expanded wide color gamut. To further reduce the possible contouring artifacts happening, the system may spatially filter the skin score of pixel with its neighbors. After this filtering, the skin score is not only smooth in the color space but also smooth spatially.

For sky color, people prefer the sky color to be more saturated than the original color. In wide-color gamut display, the gamut of the input sky image will be stretched by the display, this will naturally increase the saturation of the input image (including the sky region). So in wide-color gamut display, small amount of saturation boosting or no saturation boosting is needed, depending on the preference of the observer. On the contrast, in standard-color gamut display, the sky color will need to be saturation-boosted a significant amount.

The output of the sky detection and enhancement module is a weighted average of the input and the enhanced image. The color enhancement module increases the saturation of the input image based on user-adjustable saturation boosting-amount. The enhancement can take place in any color space such as YCbCr, HSV, IPT.

One difference between skin enhancement and sky enhancement is that, since the sky enhancement do not preserve the input color but rather allow it to be saturation-boosted, therefore the sky enhancement does not need to know the primaries (red, green, blue and white point) and the gamma function of the target display. In contrast, the skin enhancement should use this information in the gamut mapping techniques.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A image enhancement technique comprising:
(a) a filter receives said image and generates a filtered image primarily including lower frequency content and sharp edges of said image;
(b) a skin color processing that based upon said filtered image enhances skin tone regions of said image;
(c) a sky color processing that based upon said filtered image enhances sky color regions of said image;
(d) a combiner that calculates an output image based upon said skin color processing, said sky color processing, and higher frequency content of said image.

2. The technique of claim 1 wherein said filter is a sieve filter.

3. The technique of claim 1 wherein the color gamut of said image is smaller than the output gamut of said output image.

4. The technique of claim 3 wherein said image has a sRGB color gamut.

5. The technique of claim 1 wherein said higher frequency content is determined based upon said filtered image and said image.

6. The technique of claim 1 wherein said skin color processing is based upon a skin color look up table.

7. The technique of claim 1 wherein said skin color processing is based upon a sky color look up table.

8. The technique of claim 1 wherein sky color processing is based upon the results of said skin color processing.

9. The technique of claim 1 wherein said sky color processing is not based upon the results of said skin color processing.

10. The technique of claim 1 wherein said skin color processing is based upon a skin color look up table, said skin color processing is based upon a sky color look up table, and where said skin color look up table is substantially non-overlapping with said sky color look up table.

11. The technique of claim 6 wherein said look up table is pre-computed.

12. The technique of claim 7 wherein said look up table is pre-computed.
